(19) United States
(12) Patent Application Publication
(10) Pub. No.: US 2017/0083713 A1
(43) Pub. Date: Mar. 23, 2017

(54) DATA ENCRYPTION SCHEME USING SYMMETRIC KEYS

(71) Applicants: Sean Bartholomew SIMMONS, Waterloo (CA); Nagula Tharma SANGARY, Waterloo (CA); Mahinthan VELUPPILLAI, Kitchener (CA)

(72) Inventors: Sean Bartholomew SIMMONS, Waterloo (CA); Nagula Tharma SANGARY, Waterloo (CA); Mahinthan VELUPPILLAI, Kitchener (CA)

(21) Appl. No.: 14/862,869

(22) Filed: Sep. 23, 2015

(51) Int. Cl. G06F 21/62; H04L 9/30; H04L 9/08

(52) U.S. Cl. CPC G06F 21/6209; H04L 9/0869; H04L 9/30

(57) ABSTRACT

In one aspect there is provided a computer-implemented method for encrypting a data element. The method includes generating a symmetric key and encrypting the data element using the symmetric key. The method also includes identifying one or more entities in a policy database that are authorized to access the data element, and retrieving a public key associated with each of the one or more entities. The method also includes, for each entity of the entities that are authorized to access the data element, encrypting the symmetric key using the public key associated with the entity to obtain an encrypted symmetric key, and appending the encrypted symmetric key to a file storing the encrypted data element.

### TECHNICAL FIELD

Example embodiments relate generally to techniques for data encryption and storage of encrypted data, and more particularly to encrypting data using symmetric keys.

### BACKGROUND

Users of computing systems generate a large volume of data, some of which may be private and sensitive in nature. One example of private data may be sensor data generated by sensor devices that measure personal parameters, such as health monitoring devices. The growth of sensor devices and of computing devices incorporating sensors has resulted in a great amount of sensor data being collected.

While users may wish to keep private data confidential and away from prying eyes, users may also wish to selectively share their private data to gain additional benefits from the data. In one example, a user uses a sensor device to collect health data regarding her health. The user may wish to share the data with health professionals, such as doctors and insurance providers. By sharing the data with the professionals, the user may benefit from a professional analysis of the data. However, at the same time, the user may wish to keep the data confidential from outsiders. Accordingly, it may be advantageous to provide a system for selectively sharing data.

### SUMMARY OF EXAMPLE EMBODIMENTS

In one aspect there is provided a computer-implemented method for encrypting a data element. The method comprises generating, using a pseudorandom number generator, a symmetric key associated with the data element; encrypting the data element using the symmetric key associated with the data element to obtain an encrypted data element; storing the encrypted data element in a file; retrieving, from memory, a policy database defining entities authorized to access the data element, each entity of the one or more entities having a public key associated therewith stored in memory; identifying one or more entities in the policy database that are authorized to access the data element, and retrieving, from memory, a public key associated with each of the one or more entities; and for each entity of the one or more entities that is authorized to access the data element, encrypting the symmetric key using the public key associated with the entity to obtain an encrypted symmetric key, and appending the encrypted symmetric key to the file.

In another aspect the method further comprises receiving the data element from a sensor device, the data element including sensor data, and generating the symmetric key in response to receiving the data element including sensor data from the sensor device.

In another aspect there is provided a computing-device comprising a processor; and memory coupled to the processor and storing instructions for encrypting a data element. The processor may be configured to: generate, using a pseudorandom number generator, a symmetric key associated with the data element; encrypt the data element using the symmetric key associated with the data element to obtain an encrypted data element; store the encrypted data element in a file in the memory; retrieve, from the memory, a policy database defining entities authorized to access the data element, each entity of the one or more entities having a public key associated therewith stored in memory; identify one or more entities in the policy database that are authorized to access the data element, and retrieve, from the memory, a public key associated with each of the one or more entities; and for each entity of the one or more entities that is authorized to access the data element, encrypt the symmetric key using the public key associated with the entity to obtain an encrypted symmetric key, and append the encrypted symmetric key to the file.

In yet another aspect, there is provided a non-transient computer readable medium containing program instructions for causing a computing device to perform the method of: generating, using a pseudorandom number generator, a symmetric key associated with the data element; encrypting the data element using the symmetric key associated with the data element to obtain an encrypted data element; storing the encrypted data element in a file; retrieving, from memory, a policy database defining entities authorized to access the data element, each entity of the one or more entities having a public key associated therewith stored in memory; identifying one or more entities in the policy database that are authorized to access the data element, and retrieving, from memory, a public key associated with each of the one or more entities; and for each entity of the one or more entities that is authorized to access the data element, encrypting the symmetric key using the public key associated with the entity to obtain an encrypted symmetric key, and appending the encrypted symmetric key to the file.

### BRIEF DESCRIPTION OF THE DRAWINGS

Reference will now be made, by way of example, to the accompanying drawings which show example embodiments, and in which:

FIG. 1 illustrates in block-diagram form an example environment within which example embodiments can be practiced;

FIG. 2 illustrates in block-diagram form a storage device suitable for storing data in accordance with example embodiments;

FIG. 3 illustrates in block-diagram form a backup server for use with the storage device of FIG. 2;

FIG. 4 illustrates in block-diagram form a third-party device for use with the storage device of FIG. 2;

FIGS. 5A, 5B, 5C and 5D illustrate in block-diagram form example files storing encrypted data elements in accordance with example embodiments; and

FIG. 6 illustrates an example flowchart of a method for encrypting data elements and for storing encrypted data elements at the storage device of FIG. 2.

Similar reference numerals may have been used in different figures to denote similar components.

### DETAILED DESCRIPTION OF EXAMPLE EMBODIMENTS

A storage device is configured to receive data elements for encryption and storage. For each data element received at the storage device, the storage device may generate a symmetric key and encrypt the data element using the symmetric key. In one embodiment, the symmetric key is associated with a data element and is only used to encrypt one data element.

The storage device may receive data from sensor devices that collect and send sensor data to the storage device. The storage device may determine which entities are authorized to view each data element received at the storage device. Entities may include corporations (e.g. health-insurance companies), professionals (e.g. doctors), and individuals (e.g. relatives of the user). The storage device may store a policy database defining entities that are authorized to access each data element the storage device receives. Access may be defined based on the device that sent the data element to the storage device. For example, only entities associated with health-professionals may be authorized to access data collected by a blood pressure monitoring sensor device, and on the other hand, only entities associated with home-monitoring professionals may be authorized to access data collected by a security perimeter sensor device.

The storage device may share the encrypted data element with the authorized entities. However, the authorized entities do not know the symmetric key used to encrypt the data element. Accordingly, the storage device must also send the symmetric key to the authorized entity. However, sending the symmetric key in plaintext would jeopardize the security of the encrypted data element and allow attackers to decrypt the encrypted data elements. Accordingly, the storage device may encrypt the symmetric key using a key that the authorized entity can decrypt; such as a public key associated with the authorized entity. The public key associated with the authorized entity is part of a key pair. The key pair includes a private key, which is kept secret and is only known to the authorized entity, and the public key. The private key is needed to decrypt data encrypted using the public key of the key pair.

The storage device may thus store public keys associated with various entities. The storage device may encrypt the symmetric key using the public key of each authorized entity. If multiple entities are authorized to access the data element, the storage device may encrypt the symmetric key multiple times—once for each authorized entity, using the public key associated with each authorized entity. The storage device may append the encrypted symmetric key or keys to the file storing the encrypted data element. The storage device may thus provide selective access to sensor data based on the policy database.

The encrypted data stored at the storage device may be sent to other entities that are not authorized to access data without jeopardizing the security of the data. Unauthorized entities do not have the private key needed to decrypt the encrypted symmetric keys. The storage device may therefore send the encrypted data to a backup server for storage without jeopardizing the security of the data. If the backup server is not an authorized entity, then the backup server will be unable to decrypt the encrypted data.

The storage device may act as a hub for user data, such as sensor data. The storage device and the sensor devices may be implemented using fog computing and fog networking architecture principles. The storage device may be implemented as an end-user device in some embodiments, and carries out data storage, encryption, and management functions on behalf of the sensor devices. Fog computing principles may help improve privacy and security associated with data storage. For example, the sensor devices may utilize a private local network (e.g. an Intranet) to communicate with the storage device.

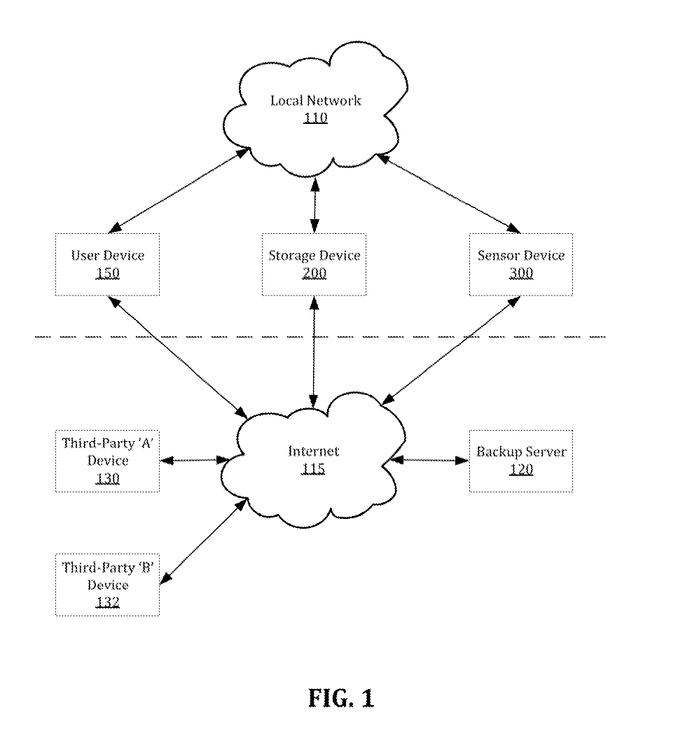

FIG. 1 illustrates an example environment within which the techniques of the example embodiments may be practiced. As shown in FIG. 1, storage device 200 and sensor device 300 are communicatively coupled to one another via location network 110 or via Internet 115. Sensor device 300 includes at least one sensor, such as an accelerometer, a barometer, a flow sensor, a carbon monoxide sensor, a smoke sensor, a heat sensor, a thermometer, a blood glucose sensor, a cholesterol sensor, a magnetometer, an oxygen sensor, and a pH sensor. Sensor device 300 may collect sensor data, which may be associated with one or more users, and may send the sensor data to storage device 200 at periodic intervals. Storage device 200 may receive, via local network 110 or via Internet 115, the sensor data from sensor device 300.

Optionally, storage device 200 may also be coupled to a user device 150, via local network 110 or Internet 115. User device 150 may be any one of a mobile phone, smartphone or superphone, tablet computer, notebook computer (also known as a laptop, netbook or ultrabook computer depending on the device capabilities), wireless organizer, personal digital assistant (PDA). As will become apparent, user device 150 may perform substantially the same functions as storage device 200; for example, user device 150 may be coupled to sensor device 150 and may receive data from sensor device 300 via local network 110 or via Internet 115. User device 150 may also encrypt and store data in accordance with the embodiments described.

Local network 110 may act as an intranet, connecting local computing device to one another. Local network 110 may be configured as a wired or wireless personal area network (PAN) in accordance with any known communication protocols, including, without limitations, INSTEON, Wi-Fi™, Wi-Fi Direct™, Infrared Data Association (IrDA), wired or wireless USB™, Bluetooth™, Z-Wave™, and ZigBee™. Local network 110 may alternatively include a routing device and be configured as a local area network (LAN) or a wireless local area network (WLAN), or may include elements of both a PAN and a LAN.

Storage device 200 (and user device 150) may also be coupled to a backup server 120, via Internet 115. Storage device 200 may optionally send encrypted sensor data collected by sensor device 300 to backup server 120 for routine and regular backup of the sensor data. Storage device 200 may also send to backup server 120 user identification information associated with the sensor data. Backup server 120 may store the received sensor data in a database.

Storage device 200 and backup server 120 (and user device 150) may also be coupled to third-party devices, via Internet 115. Shown in FIG. 1 are third-party ‘A’ device 130 and third-party ‘B’ device 132. Each third-party device may be associated with an entity. Storage device 200 may send data directly, via the Internet, to one of the third-party devices. Alternatively, storage device 200 may send data to backup server 120 for storage. One or more third-party devices may then send a request to backup server 120 to receive data associated with one or more users. Backup server 120 may send, via Internet 115, data elements to third-party devices that are authorized to access the data elements.

In one embodiment, third party ‘A’ device 130 is owned and operated by a healthcare provider (such as any one of a doctor, a hospital, and a health insurance company) and sensor device 300 is configured to collect and store health data associated with a user. When the user visits the healthcare provider, the healthcare provider will benefit from accessing the sensor data to provide better services to the user. The user may therefore authorize the healthcare provider to access the data associated with sensor device 300. Third party ‘A’ device 130 may send a request to access health related sensor data to either backup server 120 or storage device 200.

While user device 150, storage device 200, and sensor device 300 are shown as three separate devices in FIG. 1, in some embodiments, the functionality associated with each of the three devices may be implemented in a single device. Furthermore, in some embodiments, storage device 200 may not be connected to user device 150 and sensor device 300 via a local network, and instead, the devices may communicate with one another via Internet 115.

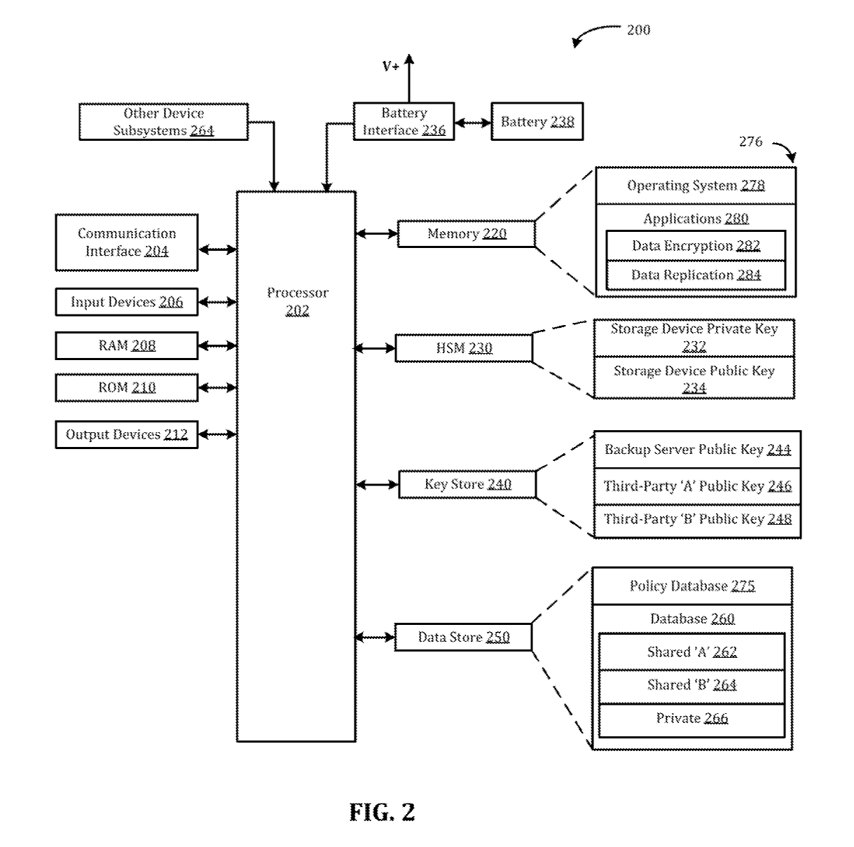

Having illustrated example environments within which the techniques of the example embodiments may be practiced, now more details regarding the storage device 200 will be described, as shown in FIG. 2. FIG. 2, illustrates, in block diagram form, an example storage device 200 suitable for encrypting data in accordance with example embodiments. Examples of storage device 200 include, but are not limited to, a notebook computer (also known as a laptop, netbook or ultrabook computer depending on the device capabilities), a desktop computer, a purpose-built server computer, and a generic server computer.

Storage device 200 may include a rigid case (not shown) housing the electronic components of storage device 200. The electronic components of storage device 200 may be mounted on a printed circuit board (not shown) and/or communicatively coupled thereto by a communications cable. Storage device 200 includes a processor 202, which controls the overall operation of storage device 200. Communication functions are performed through a communication interface 204. Communication interface 204 receives data and messages and sends data and messages via either Internet 115 or local network 110. Communication interface 204 typically includes an Ethernet interface for communication over wired networks, and a WLAN interface for communication over Wi-Fi™ and/or Bluetooth™ networks.

Processor 202 interacts with other components including one or more input devices 206 (such as a pushbutton, a keyboard, and/or touch-sensitive display), one or more output devices 212 (such as an LED, and/or a display), RAM 208, ROM 210, persistent (non-volatile) memory 220, auxiliary I/O subsystems (not shown), one or more data port (not shown) such as serial data port (e.g., USB data port), data store 250, HSM 203, key store 240, and other device subsystems generally designated as 264. The components of storage device 200 are coupled via a communications bus (not shown) which provides a communication path between the various components.

Processor 202 operates under stored program control and executes software modules 276 stored in memory 220. As illustrated in FIG. 2, the software modules 276 comprise operating system software 278 and software applications 280. The software applications 280 may include a data encryption application 282 and a data replication application 284. The software modules 276 or parts thereof may be temporarily loaded into volatile memory such as the RAM 208. The RAM 208 is used for storing runtime data variables and other types of data or information. Although specific functions are described for various types of memory, this is merely one example, and a different assignment of functions to types of memory could be used.

Input devices 206 may include a keyboard, control buttons (not shown) such as a power toggle (on/off) button, volume buttons, general purpose or context specific buttons, ‘back’ or ‘home’ buttons, and/or a navigation device. When a display screen is provided as part of a touchscreen, the various buttons or controls may be provided by onscreen user interface elements displayed on the display screen instead of, or in addition to, physical interface components. The keyboard may be provided instead of, or in addition to, a touchscreen depending on the embodiment. At least some of the control buttons may be multi-purpose buttons rather than special purpose or dedicated buttons.

Output devices 212 may include an LED indicator, a touch-sensitive display, a dot-matrix display or other type of display. Output devices 212 are operably coupled to an electronic controller (not shown) and to processor 202. User-interaction with a GUI (graphical user interface) is performed through input devices 206. Information, such as LED light patterns, text, characters, symbols, images, icons, and other items are rendered and displayed on output devices 212 via processor 202.

Storage device 200 may optionally include a battery 238 to provide a power source. Typically, one or more rechargeable batteries are used, which may be charged, for example, through charging circuitry coupled to a battery interface such as a serial data port (not shown). Battery 238 provides electrical power to at least some of the electrical circuitry in sensor device 200, and battery interface 236 provides a mechanical and electrical connection for battery 238. Battery interface 236 is coupled to a regulator (not shown) which provides power V+ to the circuitry of sensor device 200.

Communication interface 204 may include a short-range wireless communication subsystem (not shown) which provides a short-range wireless communication interface. The wireless communication interface may be configured in accordance with one or more cellular telecommunication standards, including any of a Bluetooth™ standard, an IEEE 802.11 standard (also referred to as Wi-Fi™), an IEEE 802.15.3a standard (also referred to as UWB), a Z-Wave standard, a ZigBee™ standard or other suitable short-range wireless communication standard. A received signal, such as a message or sensor data, is processed by communication subsystem 204 and input to processor 202. Processor 202 encrypts the received signal in accordance with the data encryption application 282 or any other application in the memory 220.

Processor 202 is also communicatively coupled with data store 250, which is a computer readable medium for long-term data storage, such as a hard-disk drive, a solid-state drive, an optical storage device, and a magnetic tape. Data store 250 stores data, including user data in database 260 and a policy database 275 defining rules for storage, encryption, and access of data stored in database 260. Policy database 275 may specify which entity or entities are authorized to access data received from each sensor device. For example, data from a sensor device collecting blood-pressure measurements may be associated in the policy database 275 with a health-monitoring entity. Policy database 275 may also store rules specifying the frequency at which data from each sensor device should be sent to backup server 120 (e.g. never, every hour, every day, every week, ect).

Database 260, on the other hand, stores data received from sensor devices and other user data. As shown, database 260 includes three partitions, Shared ‘A’ 262, Shared ‘B’ 264, and Private 266. Policy database 275 may include rules specifying which partition data from each sensor device should be stored. For example, policy database 275 may require that all health related data be stored in partition Shared ‘A’ 262, all home monitoring related data be stored in partition Shared ‘B’ 264, and all financial information be stored in partition Private 266. Policy database 275 may further specify which entities are authorized to access data stored in each partition. For example, a health monitoring entity may be authorized to access data stored in partition Shared ‘A’ 262, a home monitoring entity may be authorized to access data stored in partition Shared ‘B’ 264, and no third-party may be authorized access to data stored in partition Private 266 (i.e. only sensor device 200 may access the data in stored in the partition, such as financial data).

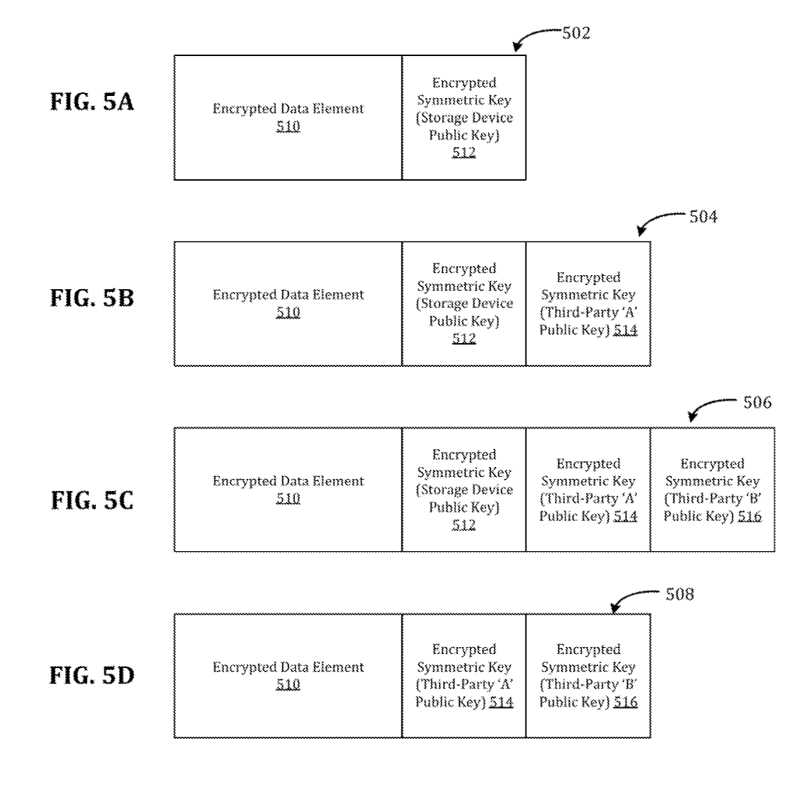

Database 260 may be implemented using a NoSQL database (such as CouchDB™, or MongoDB™) using unstructured data. When storage device 200 receives a data element storing sensor data from a sensor device, storage device 200 may encrypt the data element in accordance with example embodiments. Storage device 200 may then store the encrypted data element in database 260 in accordance with the rules set out in policy database 275. A file storing encrypted data is thus created and stored in database 260. Example files are shown in FIGS. 5A-5D.

Processor 202 may also be communicatively coupled with Hardware Security Module (′FISM′) 230. HSM 230 provides secure, tamper proof storage for encryption keys, and stores storage device private key 232 and storage device public key 234. Private and public keys 232, 234 are a mathematically linked key-pair associated exclusively with storage device 200. Private and public keys 232, 234 may be created by storage device 200 during initial set-up, or alternatively, storage device 200 may receive private and public keys 232, 234 during manufacturing of storage device 200. Public key 234 associated with storage device 200 may be distributed freely amongst users of the system, however, private key 232 is kept secret from all other devices. Public key 232 may be used to identify storage device 200 to other devices in the system, such as backup server 120 or third-party ‘A’ device 130 or third-party ‘B’ device 132, by sending public key 232 to the other device.

In some embodiments, storage device 200 may send public key 234 to a certificate authority (CA), which may be implemented using backup server 120. Upon receiving the public key from storage device 200, the CA may encrypt public key 234 using the private key associated with backup server 120. Public key 234 is now said to be ‘signed’. Backup server 120 sends the signed public key back to storage device 200, which storage device 200 may store in HSM 230 (not shown). Public key 234 is now said to be ‘registered’ with backup server 120, and may be used to securely identify public key 234 as being associated with storage device 200.

Processor 202 may also be communicatively coupled with key store 240, which stores public keys associated with various entities that storage device 200 is registered with, such as backup sever public key 244, third-party ‘A’ pubic key 246, and third-party ‘B’ public key 248.

Backup server 120 public key 244 may be distributed to every device which utilizes the system. Accordingly, any device is able to decrypt a signed public key. If a device receives a signed public key, the device can verify that the public key has been registered with backup server 120 by decrypting the signed public key using the public key associated with backup server 120. Since backup server 120 is a trusted entity, an entity that has a public key signed by backup server 120 may be trusted by other entities. Each device may therefore send the signed public key associated with it to identify itself to other devices and may rely on signed public keys as proof of identity.

Storage device 200 may register with a third-party entity by sending a request to a device associated with the third-party entity (e.g. third-party ‘A’ device 130 or third-party ‘B’ device 132), via Internet 115, to receive the unsigned or signed public key associated with the device. Upon receiving a signed public key, storage device 200 may decrypt the signed public key using the public key associated with backup server 120, then store the public key associated with the device in key store 230. As shown in FIG. 2, key store 230 stores the public keys associated with Third-Party ‘A’ and Third-Party ‘B’. By registering with the third-party entity, and by receiving and storing the third-party entity public keys, storage device 200 is able to provide the third-party entity access to at least a subset of data stored on storage device 200 by using the third-party entity public key to encrypt the symmetric keys which it encrypts data elements with. Furthermore, when storage device 200 registers with a third-party entity, policy database 275 may be updated to indicate data the third-party entity is authorized to access.

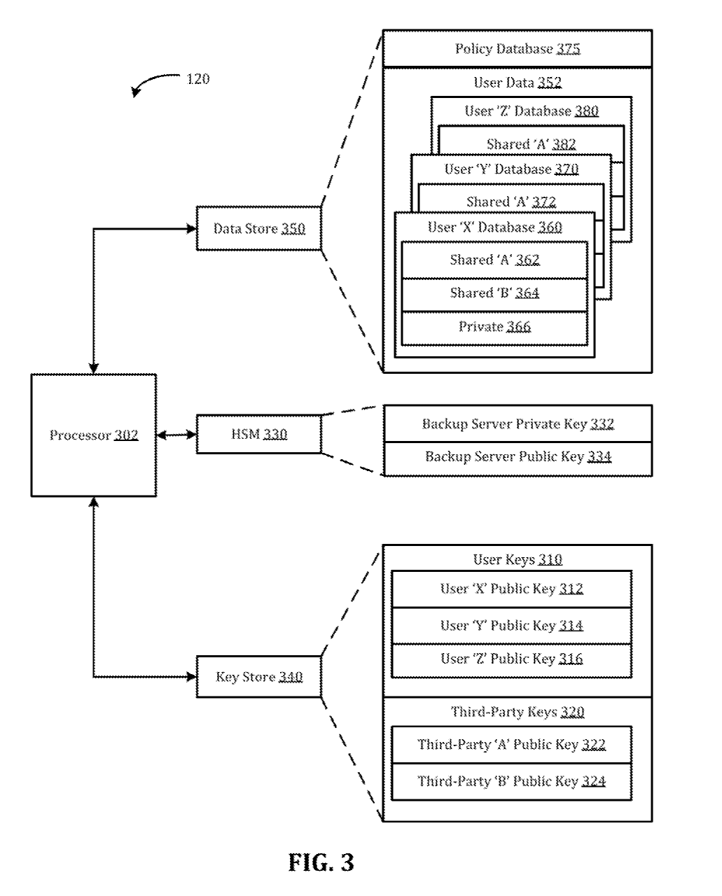

Reference is next made to FIG. 3 which illustrates in block diagram form an example backup server 120 suitable for storing data encrypted by storage device 200 and sending stored data to third-party devices in accordance with example embodiments. FIG. 3 only illustrates select components of backup server 120. Backup server 120 may receive data from one or more storage devices 200 for backup storage and for routing to other entities (e.g. to third-party device 130).

Backup server 120 includes a processor 302 which controls the overall operation of backup server 120. Processor 302 may interact with other components (not shown) including one or more input devices, RAM, ROM, persistent (non-volatile) memory, auxiliary I/O subsystems, one or more data port such as serial data port (e.g., USB data port), and other device subsystems. The components of the backup server 120 are coupled via a communications bus (not shown) which provides a communication path between the various components. As illustrated in FIG. 3, backup server 120 also includes data store 350, HSM 330, and key store 340, which may interact with processor 302.

HSM 330 may store backup server private and public keys 332, 334. Private and public keys 332, 334 are a mathematically linked key-pair associated exclusively with backup server 120. Backup server private key 332 may be used by the CA of backup server 120 to sign public keys associated with other devices in the system. Backup server public key 332 may thus be widely distributed to allow for other devices to decrypt signed keys.

Key store 340 may store user keys 310 (for example, User ‘X’ public key 312, User ‘Y’ public key 314, User ‘Z’ public key 316, and so forth). User keys are public keys associated with registered users, and may be received at backup server 120 from storage devices associated with various users during a registration process. The user keys may be used to uniquely identify different users and the storage devices associated with the users.

Key store 340 may also store third-party keys 320 (for example, third-party ‘A’ public key 322, third-party ‘B’ public key 324, and so forth). Third-party keys are public keys associated with registered third-party entities (e.g. a health-monitoring entity, or a home-monitoring entity). Third-parties may utilize data stored at storage devices and backup server 120 associated with users to provide services to users. Accordingly, users may wish to share their data with such third-party entities. However, there is no need for all third-party entities to receive all data associated with all users. For example, a home-monitoring entity may not need health data associated with the users. Accordingly, a system and method for storing backup data and selectively providing access to user data is advantageous.

Backup server 120 may receive data elements associated with one or more users from one or more storage devices 200. Backup server 120 includes data store 350, which may store a user data database 352. User data database may be implemented using a NoSQL database (such as CouchDB™, or PouchPC) using unstructured data.

Data elements received from each storage device 200 is associated with a user/storage device and may be stored in a separate database associated with the user/storage device. Each database may be associated with one of user keys 310 (i.e. User ‘X’ database 360 is associated with User ‘X’ public key 312, etc.). As shown in FIG. 3, user data 352 includes three databases, each storing data associated with a different user/storage device: User ‘X’ database 360, storing data associated with User ‘X’; User ‘Y’ database 370, storing data associated with User ‘Y’; and User ‘Z’ database 380, storing data associated with User ‘Z’. Each user data 352 database may include any number of databases to accommodate more or less users. In some embodiments, each storage device 200 is associated with a single user; thus, data received from a particular storage device is automatically stored in the corresponding user database. In other embodiments, each storage device 200 may be associated with more than one user, and data received from a multiuser storage device is stored in the corresponding user database based on a user ID sent by the multiuser storage device and received at backup server 120.

Each user database 360, 370, and 380 in user data 352 replicates the different partitions stored on the corresponding storage device. As shown in FIG. 3, User ‘X’ database 360 includes three partitions: Shared ‘A’ 362, Shared ‘B’ 364, and Private 366. The partitions may be mirror images of the partitions stored on the corresponding user storage device. Similarly, as shown in FIG. 3, User ‘Y’ database 370 includes partition Shared ‘A’ 372, and User ‘Z’ database 380 includes partition Shared ‘A’ 382. Each user database may include any number of partitions.

Upon receiving a data element (e.g. from storage device 200), backup server 120 may store the data element in the user database corresponding with the user of the storage device that sent the data element. Storage device 200 may also send public keys associated with entities authorized to access the data element, thereby allowing backup server 120 to store each data element in the partition or partitions associated with the authorized entity or entities. Backup server 120 may also assign each data element received at backup server 120 a unique ID to identify the data element. The unique ID may be appended to the file storing the data element or may be assigned to the data element in a database (not shown).

Backup server 120 may also generate a hash (e.g. using Secure Hash Algorithm (‘HSM’)) of all unique IDs stored in each partition. The hash of the unique IDs provides a representation of the state of data stored in each partition at the backup server. Backup server 120 may thus compare the state of data stored in each partition at the backup server with the state of data stored in another partition at another device by generating a hash of the unique IDs. If the hash is identical, then the two partitions store the same data elements. This allows backup server 120 to determine the state of each partition without decrypting the data elements. Backup server 120 may send the unique ID associated with each data element to storage device 200 and/or third-party devices 130, 132.

Data store 350 may also store a policy database 375. Policy database 375 may define entities that are authorized to access each of the one or more partitions in each user database. Backup server 120 may send data stored in user data database 352 to authorized entities.

Policy database 375 may use the public key associated with each user (as stored in user keys 310) as a unique key. For example, policy database 375 may store the data shown Table 1 to define authorized entities for partitions of User ‘X’ database 360. As shown in Table 1, policy database may include four data fields: UserID, uniquely identifying the user with the corresponding user public key; UserDatabase, identifying the user database stored in user data 352; UserPartition, identifying a particular partition in the identified user database; and AuthorizedEntity, identifying one or more entities by the public key associated with the third-party entity authorized to access data stored in the particular partition. As shown in Table 1, Third-Party ‘A’ is authorized to access data stored in partition Shared ‘A’ 362 in User ‘X’ Database 360; Third-Party ‘B’ is authorized to access data stored in partition Shared ‘B’ 364 in User ‘X’ Database 360; and User ‘X’ is authorized to access data stored in partition Private 366 in User ‘X’ Database 360.

TABLE 1

| [k] UserID | User ‘X’ | User ‘X’ | User ‘X’ Public Key |
|---|---|---|---|
| | Public Key 312 | Public Key 312 | 312 |
| UserDatabase | User ‘X’ | User ‘X’ | User ‘X’ Database |
| | Database 360 | Database 360 | 360 |
| UserPartition | Shared ‘A’ 362 | Shared ‘B’ 364 | Private 366 |
| AuthorizedEntity | Third-Party ‘A’ | Third-Party ‘B’ | User ‘X’ Public Key |
| | Public Key 322 | Public Key 324 | 312 |

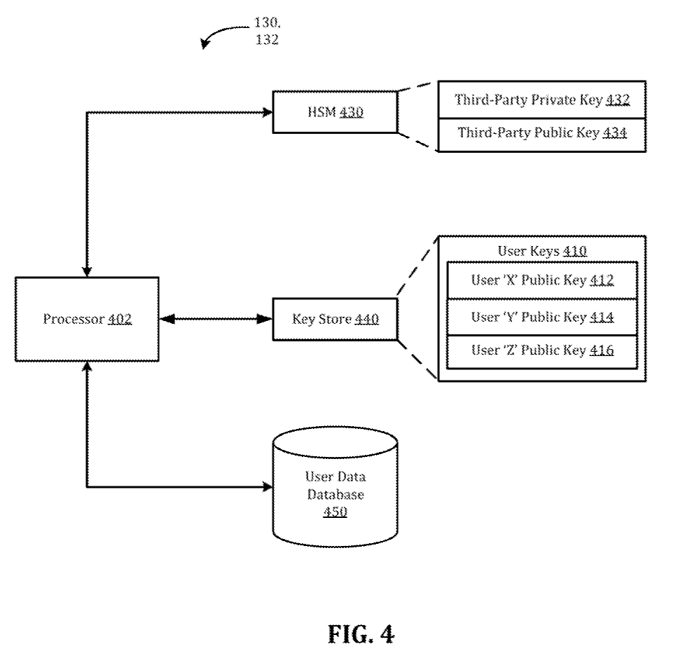

Reference is next made to FIG. 4 which illustrates in block diagram form an example third-party device 130, 132 (hereinafter referred to as third-party device 130) suitable for storing data encrypted by storage device 200 in accordance with example embodiments. FIG. 4 only illustrates select components of third-party device 130. Third-party device 130 may receive user data from storage device 200 or from backup device 120 in accordance with policy database 275 and/or 375. Third-party device 130 may be associated with an entity which may utilize user data to provide services to users.

Third-party device 130 includes a processor 402 which controls the overall operation of third-party device 130. Processor 402 may interact with other components (not shown) including one or more input devices, RAM, ROM, persistent (non-volatile) memory, auxiliary I/O subsystems, one or more data port such as serial data port (e.g., USB data port), and other device subsystems. The components of the third-party device 130 are coupled via a communications bus (not shown) which provides a communication path between the various components. As illustrated in FIG. 4, third-party device 130 also includes user data database 450, HSM 430, and key store 440, which may interact with processor 402.

HSM 430 may store third-party device private and public keys 432, 434. Private and public keys 432, 434 are a mathematically linked key-pair associated exclusively with third-party device 130. Third-party device public key 434 may be signed by the CA of backup server 120.

Key store 440 may store user keys 410 (for example, User ‘X’ public key 412, User ‘Y’ public key 414, User ‘Z’ public key 416, and so forth). User keys 410 are public keys associated with registered users, and may be received at third-party device 130 from storage devices associated with various users during a registration process. The user keys may be used to uniquely identify different users and the storage devices associated with the users.

User data database 450 may store data associated with users of one or more storage devices 200, include sensor data and other data. User data database 450 may be implemented using an SQL database to allow for easy retrieval of data. Third-party device 130 may receive the user data from either backup server 120 or from storage device 200. Each data element received may be associated with a particular user, as identified by the user's public key. Additionally, each data element received may be encrypted. Accordingly, third-party device 130 may decrypt the received data elements, then store plaintext data elements in user data database 450. Each data element in user data database 450 may be associated with the corresponding user's public key. Each data element may also be associated with its unique ID.

Reference is now made to FIGS. 5A-5D, which illustrate, in block-diagram form, example files 502, 504, 506, and 508, respectively. Each file stores an encrypted data element 510. Encrypted data element 510 may contain encrypted sensor data. Additionally, each file stores one or more encrypted symmetric keys to allow each entity that is authorized to access the data element, as defined in policy database 275, to decrypt the data element. Files 502, 504, 506, and 508 may be produced by storage device 200 and may be stored in data store 250 of storage device 200. Storage device 200 may also send the files to backup server 120, which may also store the files in data store 350 of backup server 120. Backup server 120 may append to each file a unique ID associated with the file (not shown).

As shown in FIG. 5A, file 502 stores encrypted symmetric key 512 in addition to encrypted data element 510. Encrypted symmetric key 512 is encrypted using storage device public key 512. Encrypted symmetric key 512 can be decrypted using storage device private key. As previously explained, storage device private key is stored in HSM 230 of storage device 200, and is not shared with any other entity. Accordingly, only storage device 200 is capable of decrypting encrypted symmetric key 512. Furthermore, for a computing device to decode encrypted data element 510, the computing device requires encrypted symmetric key 512. Since only storage device 200 is capable of decrypting encrypted symmetric key 512, only storage device 200 is capable of accessing encrypted data element 510 of file 502. File 502 may be stored in partition Private 266 in data store 250 of storage device 200. File 502 may also be stored in partition Private 366 in data store 350 of backup server 120.

As shown in FIG. 5B, file 504 stores encrypted symmetric key 512 and encrypted symmetric key 514 in addition to encrypted data element 510. Encrypted symmetric key 512 is encrypted using storage device public key 512, whereas, encrypted symmetric key 514 is encrypted using third-party ‘A’ public key (third-party ‘A’ public key is stored in key store 240 of storage device 200). Similarly to file 502, storage device 200 is capable of accessing encrypted data element 510 of file 504 by decrypting encrypted symmetric key 512. Additionally, third-party ‘A’ device 130 is also capable of accessing encrypted data element 510 of file 504 by decrypting encrypted symmetric key 514, since third-party ‘A’ device 130 stores in HSM 430 third-party ‘A’ private key. Accordingly, both storage device 200 and third-party ‘A’ device 130 are capable of accessing encrypted data element 510 of file 504. File 504 may be stored in partition Private 266 and in partition Shared ‘A’ 262 in data store 250 of storage device 200. File 504 may also be stored in partition Private 366 and in partition Shared ‘A’ 362 in data store 350 of backup server 120.

As shown in FIG. 5C, file 506 stores encrypted symmetric key 512, encrypted symmetric key 514, and encrypted symmetric key 516 in addition to encrypted data element 510. Encrypted symmetric key 516 is encrypted using third-party ‘B’ public key (third-party ‘B’ public key is stored in key store 240 of storage device 200). Similarly to file 504, both storage device 200 and third-party ‘A’ device 130 are capable of accessing encrypted data element 510 of file 506 by decrypting encrypted symmetric key 512, 514 respectively. Additionally, third-party ‘B’ device 132 is also capable of accessing encrypted data element 510 of file 506 by decrypting encrypted symmetric key 516, since third-party ‘B’ device 132 stores in HSM 430 third-party ‘B’ private key. Accordingly, storage device 200, third-party ‘A’ 130, and third-party B′ device 132 are capable of accessing encrypted data element 510 of file 506. File 506 may be stored in partitions Private 266, Shared ‘A’ 262, and Shared ‘B’ 264 in data store 250 of storage device 200. File 506 may also be stored in partitions Private 366, Shared ‘A’ 362, and Shared ‘B’ 364 in data store 350 of backup server 120.

As shown in FIG. 5D, file 508 stores encrypted symmetric key 514 and encrypted symmetric key 516 in addition to encrypted data element 510. Accordingly, third-party ‘A’ 130 and third-party ‘B’ device 132 are capable of decrypting encrypted data element 510 of file 508. File 508 may be stored in partitions Shared ‘A’ 262 and Shared ‘B’ 264 in data store 250 of storage device 200. File 508 may also be stored in partitions Shared ‘A’ 362 and Shared ‘B’ 364 in data store 350 of backup server 120. Interestingly, while storage device 200 may create file 508, storage device 200 is not authorized to access file 508.

As shown in FIGS. 5A-5D, access to an encrypted data element may be permitted by including one or more symmetric keys encrypted using public key(s) associated with one or more authorized entities. Access to additional entities may be permitted at a later time—for example, file 502 may be created at an initial time, then file 504 may be created at a later by decrypting, by storage device 200, encrypted symmetric key 512, then encrypting the symmetric key twice, once using storage device public key 232 stored in HSM 230 and once using third-party ‘A’ public key 246 stored in key store 240. Similarly, access to a particular entity may be removed by deleting the corresponding encrypted symmetric key in the file.

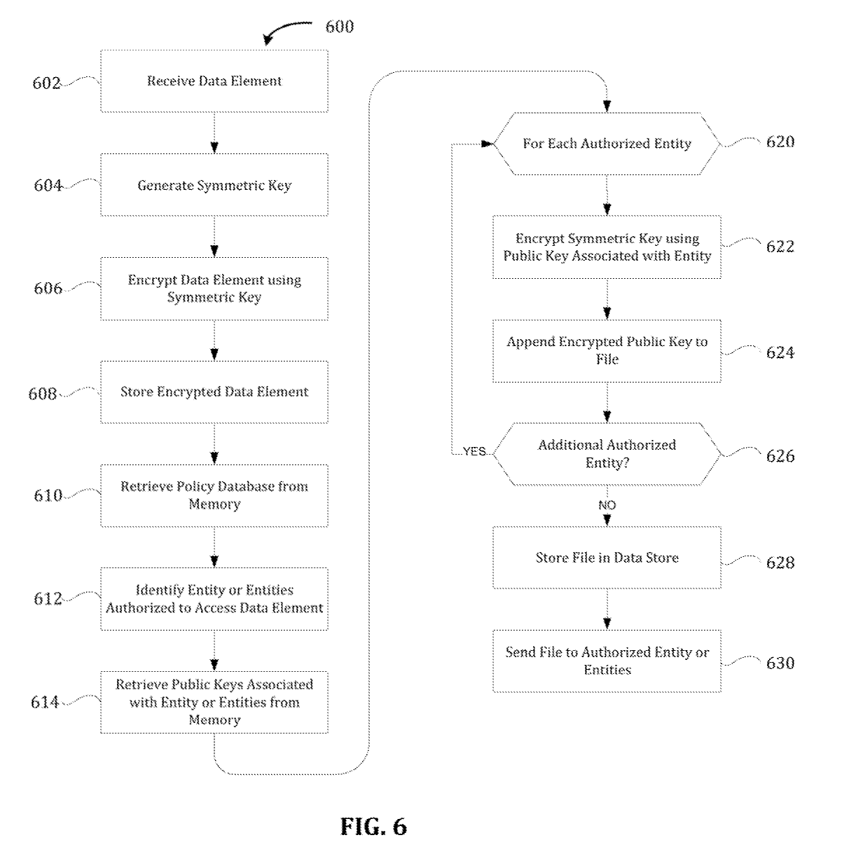

Reference is now made to FIG. 6 which illustrates a flowchart of an example method 600 for encrypting sensor data received at storage device 200. Method 600 may be implemented by storage device 200 or other device (e.g. user device 150). Method 600 may be carried out by software executed, for example, by a processor, or alternatively, by hardware components. Coding of software for carrying out such a method 600 is within the scope of a person of ordinary skill in the art. Method 600 may contain additional or fewer processes than shown and/or described, and may be performed in a different order. Computer-readable code executable by the processor 202 of storage device 200 to perform method 600 may be stored in a computer-readable medium such as memory 220 of storage device 200.

Sensor device 300 may collect sensor data and send data elements including the collected sensor data to storage device 200 at periodic intervals, or when a new measurement is taken. At block 602, storage device 200 may receive a data element from sensor device 300. In one embodiment, storage device 200 receives other user data from other devices. Such other user data may include financial information from user device 150 (user device 150 may act as a mobile wallet) or from a third-party device operated by a financial institution.

At block 604, storage device 200 may generate, using a pseudorandom number generator, a symmetric key associated with the data element of block 602. The symmetric key may be of any appropriate length, including 128, 192, and 256 bits. Storage device 200 may generate a symmetric key in response to receiving the data element at block 602. Alternatively, storage device 200 may generate symmetric keys at periodic intervals for data elements received during a predefined time period, or at a predefined time. In some embodiments, storage device 200 generates a (pseudo) unique symmetric key for each data element it receives at block 602. Accordingly, each symmetric key may be associated with a single data element.

At block 606, storage device 200 may encrypt each data element using the symmetric key associated with the data element to obtain an encrypted data element. Storage device 200 may encrypt the data element using any symmetric key algorithm, including (without limitation) Twofish, Serpent, AES (Rijndael), Blowfish, CASTS, RC4, and 3DES.

At block 608, storage device 200 may store the encrypted data element in a file in data store 250. Storage device 200 may store the encrypted data element in temporary memory (e.g. memory 220) until completion of method 600. While each encrypted data element may be stored in a separate file, in some embodiments storage device 200 may store more than one encrypted data element in the same file. This may be more efficient if the same entities are authorized to access the data elements stored in the same file. Furthermore, in some embodiments, if the same entities are authorized to access more than one data element, storage device 200 may encrypt the data elements using the same symmetric key to reduce processing time.

At block 610, storage device 200 may retrieve from memory (e.g. data store 250) policy database 275. Policy database 275 defines entities that are authorized to access each data element (e.g. based on which device sent the data element to storage device at block 602). At block 612, storage device identifies the entity or entities that are authorized to access the data element using policy database 275. For example, storage device 200 may query policy database 275 to determine a list of entities that are authorized to access data received from a particular sensor device 300. Furthermore, storage device 200 stores in memory (e.g. key store 240) a public key associated with each authorized entity. Accordingly, at block 614, storage device 200 retrieves, from memory (e.g. key store 240), the public key associated with each entity that is authorized to access the data element.

At blocks 620-626, storage device 200 may encrypt the symmetric key (generated at block 604) once using the public key (retrieved at block 614) associated with each entity that is authorized to access the data element. In particular, at block 620, storage device 200 may determine the number of authorized entities. Method 600 executes blocks 622-624 once for each authorized entity. During the first execution, at block 622, storage device 200 may encrypt the symmetric key using the public key associated with the first authorized entity, and at block 624 storage device 200 may append the encrypted public key associated with the first authorized entity to the file storing the encrypted data element. Storage device 200 may append the encrypted public key to the file or to a header of the file, or may generate a new file including the encrypted data element and the encrypted public key.

At block 626, storage device 200 determines whether an additional entity is authorized to access the data element. If so, then method 600 returns to block 622. During the second execution, at block 622, storage device 200 may encrypt the symmetric key using the public key associated with the second authorized entity, and at block 624 storage device 200 may append the encrypted public key associated with the first authorized entity to the file storing the encrypted data element. Execution of blocks 622-624 may continue until the symmetric key is encrypted once using the public key of each authorized entity.

At block 628, storage device 200 may store the file (which includes the encrypted data element and encrypted symmetric keys) in data store 250. Storage device 200 may store the file in the partition or partitions associated with the authorized entity or entities. For example, if two entities are authorized to access the data element, storage device 200 may store the file in the partition associated with each of the two entities.

At block 630, storage device 200 may send the file to the authorized entity or entities. Storage device 200 may send the file directly to each entity via Internet 115. Alternatively, storage device may send the file to backup server 120 for distribution by backup server 120 to the authorized entity or entities.

In one example, third-party ‘A’ and the user associated with storage device 200 are authorized to access the data element. Accordingly, two entities are authorized to access the data element. The file created by method 600 may include the encrypted data element, the symmetric key encrypted using the third-party ‘A’ public key, and the symmetric key encrypted using the storage device public key (e.g. see file 504 of FIG. 5B). File 504 may be stored in partition Private 266 and in partition Shared ‘A’ 262 in data store 250 of storage device 200. Storage device 200 may then send file 504 to third-party ‘A’ device 130. Storage device 200 may send file 504 directly to third-party ‘A’ device 130, or may send file 504 to backup server 120, which may then send file 504 to third-party ‘A’ device 130. Storage device 200 may decrypt the encrypted data element by first decrypting the symmetric key using its private key, then using the encrypted symmetric key to encrypt the data element. Similarly, third-party ‘A’ device may decrypt the encrypted data element by first decrypting the symmetric key using its private key, then using the encrypted symmetric key to encrypt the data element. Accordingly, a device, system, and method for encrypting data elements is provided. The device, system, and method allow for selective access to data elements based on rules stores in a policy database.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar computer readable medium including program instructions stored thereon for performing the methods described herein.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. A computer-implemented method for encrypting a data element, the method comprising:
generating, using a pseudorandom number generator, a symmetric key associated with the data element;
encrypting the data element using the symmetric key associated with the data element to obtain an encrypted data element;
storing the encrypted data element in a file;
retrieving, from memory, a policy database defining entities authorized to access the data element, each entity of the one or more entities having a public key associated therewith stored in memory;
identifying one or more entities in the policy database that are authorized to access the data element, and retrieving, from memory, a public key associated with each of the one or more entities; and
for each entity of the one or more entities that is authorized to access the data element, encrypting the symmetric key using the public key associated with the entity to obtain an encrypted symmetric key, and appending the encrypted symmetric key to the file.

2. The method of claim 1,
wherein a first entity and a second entity are authorized to access the data element,
wherein the file includes the encrypted data element, a first entity encrypted symmetric key, and a second entity encrypted symmetric key, and
wherein the first entity encrypted symmetric key is encrypted using a first entity public key and the second entity encrypted symmetric key is encrypted using a second entity public key.

3. The method of claim 2, wherein the file is stored in a database associated with the first entity.

4. The method of claim 3, further comprising sending the file to the second entity.

5. The method of claim 1, further comprising encrypting a plurality of data elements, wherein each of the plurality of data elements has a symmetric key associated therewith, and wherein each symmetric key is associated with a single data element.

6. The method of claim 5, further comprising, for each data element:
encrypting the data element using the symmetric key associated therewith to obtain an encrypted data element;
encrypting the symmetric key using one or more public keys associated with one or more entities that are authorized to access the data element to obtain one or more encrypted symmetric keys; and
storing the encrypted data element and the one or more encrypted symmetric keys in a single file.

7. The method of claim 1, further comprising receiving the data element from a sensor device, the data element including sensor data, and generating the symmetric key in response to receiving the data element including sensor data from the sensor device.

8. A computing-device comprising:
a processor; and
memory coupled to the processor and storing instructions for encrypting a data element, wherein the processor is configured to:
generate, using a pseudorandom number generator, a symmetric key associated with the data element;
encrypt the data element using the symmetric key associated with the data element to obtain an encrypted data element;
store the encrypted data element in a file in the memory;
retrieve, from the memory, a policy database defining entities authorized to access the data element, each entity of the one or more entities having a public key associated therewith stored in memory;
identify one or more entities in the policy database that are authorized to access the data element, and retrieve, from the memory, a public key associated with each of the one or more entities; and
for each entity of the one or more entities that is authorized to access the data element, encrypt the symmetric key using the public key associated with the entity to obtain an encrypted symmetric key, and append the encrypted symmetric key to the file.

9. The computing device of claim 8,
wherein a first entity and a second entity are authorized to access the data element,
wherein the file includes the encrypted data element, a first entity encrypted symmetric key, and a second entity encrypted symmetric key, and
wherein the first entity encrypted symmetric key is encrypted using a first entity public key and the second entity encrypted symmetric key is encrypted using a second entity public key.

10. The computing device of claim 9, wherein the file is stored in a database associated with the first entity.

11. The computing device of claim 10, wherein the processor is further configured to send the file to the second entity.

12. The computing device of claim 8, wherein the processor is further configured to encrypt a plurality of data elements, wherein each of the plurality of data elements has a symmetric key associated therewith, and wherein each symmetric key is associated with a single data element.

13. The computing device of claim 12, wherein the processor is further configured to, for each data element:
encrypt the data element using the symmetric key associated therewith to obtain an encrypted data element;
encrypt the symmetric key using one or more public keys associated with one or more entities that are authorized to access the data element to obtain one or more encrypted symmetric keys; and
store the encrypted data element and the one or more encrypted symmetric keys in a single file.

14. The computing device of claim 8, wherein the processor is further configured to receive the data element from a sensor device, the data element including sensor data, and to generate the symmetric key in response to receiving the data element including sensor data from the sensor device.

15. A non-transient computer readable medium containing program instructions for causing a computing device to perform the method of:
generating, using a pseudorandom number generator, a symmetric key associated with the data element;
encrypting the data element using the symmetric key associated with the data element to obtain an encrypted data element;
storing the encrypted data element in a file;
retrieving, from memory, a policy database defining entities authorized to access the data element, each entity of the one or more entities having a public key associated therewith stored in memory;
identifying one or more entities in the policy database that are authorized to access the data element, and retrieving, from memory, a public key associated with each of the one or more entities; and
for each entity of the one or more entities that is authorized to access the data element, encrypting the symmetric key using the public key associated with the entity to obtain an encrypted symmetric key, and appending the encrypted symmetric key to the file.

16. The non-transient computer readable medium of claim 15,
wherein a first entity and a second entity are authorized to access the data element,
wherein the file includes the encrypted data element, a first entity encrypted symmetric key, and a second entity encrypted symmetric key, and
wherein the first entity encrypted symmetric key is encrypted using a first entity public key and the second entity encrypted symmetric key is encrypted using a second entity public key.

17. The non-transient computer readable medium of claim 16, wherein the file is stored in a database associated with the first entity.

18. The non-transient computer readable medium of claim 17, wherein the instructions are further configured to cause the computing device to send the file to the second entity.

19. The non-transient computer readable medium of claim 15, wherein the instructions are further configured to cause the computing device to encrypt a plurality of data elements, wherein each of the plurality of data elements has a symmetric key associated therewith, and wherein each symmetric key is associated with a single data element.

20. The method of claim 19, wherein the instructions are further configured to cause the computing device to, for each data element:
encrypt the data element using the symmetric key associated therewith to obtain an encrypted data element;
encrypt the symmetric key using one or more public keys associated with one or more entities that are authorized to access the data element to obtain one or more encrypted symmetric keys; and
store the encrypted data element and the one or more encrypted symmetric keys in a single file.
